(19) United States
(12) Patent Application Publication
(10) Pub. No.: US 2026/0350769 A1
(43) Pub. Date: Nov. 5, 2026

(54) GLARE DETECTION USING GLOBAL AND LOCALIZED FEATURE FUSION

(71) Applicant: Google LLC, Mountain View, CA (US)

(72) Inventors: Avisek Lahiri, Kolkata (IN); Junjie Ke, East Palo Alto, CA (US); Daniel Vlasic, Cambridge, MA (US); Xinwei Yao, South San Francisco, CA (US); Tianli Yu, Sunnyvale, CA (US); Feng Yang, Sunnyvale, CA (US)

(21) Appl. No.: 19/102,655

(22) PCT Filed: Nov. 4, 2022
(86) PCT No.: PCT/US2022/048979

§ 371 Date: Feb. 10, 2025

(30) Foreign Application Priority Data
Sep. 15, 2022 (IN) 202221052859

(51) Int. Cl. G06T 7/00; G06T 5/60; G06T 5/77; G06T 7/11; G06T 7/136; G06T 7/90; G06V 10/26; G06V 10/60; G06V 10/764; G06V 10/77; G06V 10/82

(52) U.S. Cl. CPC G06T 7/0002; G06T 5/60; G06T 5/77; G06T 7/11; G06T 7/136; G06T 7/90; G06V 10/26; G06V 10/60; G06V 10/764; G06V 10/7715; G06V 10/82; G06T 2207/10008; G06T 2207/10024; G06T 2207/20021; G06T 2207/20084; G06T 2207/30168; G06T 2207/30176

(57) ABSTRACT

Methods, systems, and apparatus, including computer programs encoded on a computer storage medium, for detecting glare in an image. In one aspect, a system comprises a glare detection machine learning model, the glare detection machine learning model comprising: a glare segmentation neural network that generates, from data derived from the image, a glare map that identifies one or more glare areas of the image; a feature extraction model that extracts localized image feature information corresponding to the one or more glare areas of the image; a glare scoring neural network that processes the image to generate a glare detection score representing a likelihood that the image has glare; and a glare classification model that uses at least the extracted localized image feature information and the glare score to generate a classification output that specifies whether the image has glare.

### CROSS-REFERENCE TO RELATED APPLICATIONS

This application claims the benefit of priority to Indian Patent Application number 202221052859, filed Sep. 15, 2022. The disclosure of the prior application is considered part of and is incorporated by reference in its entirety into this application.

### BACKGROUND

There has been widespread adoption of various client devices that incorporate cameras, such as smart phones and tablets. Such client devices can each operate at least one corresponding image capturing application that enables a user of the client device to capture various digital images via the camera of the client device. However, for various objects and in various conditions, captured digital images may have one or more undesirable characteristics. For example, a captured image of a photo with a reflective (e.g., glossy) surface can include undesirable reflective glare that obfuscates one or more portions of the photo in the captured image. The reflective glare can be a result of light source(s) in the environment of the client device (e.g., lamps or windows) and/or can be a result of light produced by the client device, such as light from a flash component of the client device.

### SUMMARY

This specification describes a system implemented as computer programs on one or more computers in one or more locations that implements a glare detection machine learning model that is configured to process an image to generate a classification output that specifies whether the image has glare.

In general, one innovative aspect of the subject matter described in this specification can be embodied in a system for detecting glare in an image, the system comprising one or more computers and one or more storage devices storing instructions that, when executed by the one or more computers, cause the one or more computers to perform one or more operations to implement a glare detection machine learning model, the glare detection machine learning model comprising: a glare segmentation neural network that generates, from data derived from the image, a glare map that identifies one or more glare areas of the image, each glare area being a proper subset of an area of the image and determined to include a glare component caused by a glare reflection being present in the glare area; a feature extraction model that extracts localized image feature information corresponding to the one or more glare areas of the image; a glare scoring neural network that processes the image to generate a glare detection score representing a likelihood that the image has glare; and a glare classification model that uses at least the extracted localized image feature information and the glare detection score to generate a classification output that specifies whether the image has glare.

Other embodiments of this aspect include corresponding methods comprising the operations performed by the system and computer programs recorded on one or more computer storage devices, each configured to perform the actions of the methods. One or more computer programs can be configured to perform particular operations or actions by virtue of including instructions that, when executed by data processing apparatus, cause the apparatus to perform the actions.

Implementations can include one or more of the following optional features, either alone or in combination. The one or more glare areas of the image may comprise a selected glare area of the image among the one or more glare areas of the image that has the greatest number of pixels. The glare segmentation neural network and the glare scoring neural network may each be a respective convolutional neural network having a respective plurality of neural network layers. The glare segmentation neural network may processe a monochrome version of the image to generate the glare map that assigns a glare score to each of one or more pixels in the image. The glare detection machine learning model may further generate a binarized glare map from the image and from the glare map by determining color channel values that satisfy a first threshold and glare scores that satisfy a second threshold. The binarized glare map may be partitioned into one or more segments, each segment indicative of a contour of a corresponding glare component. The feature extraction model may extract localized image feature information corresponding to the one or more identified areas of the image based on processing the binarized glare map, the image, or both. The localized image feature information may comprise one or more of: dark channel gradient energy, saturation and intensity (SV) product, Kullback-Leibler (KL) divergence of histogram, standard deviation and contrast, contour mean, hue standard deviation, saturation mean difference, median saturation of contour, or bounding box fraction. The feature extraction model may be a convolutional neural network that processes the binarized glare map, the image, or both to generate an embedded feature vector that represents the localized image feature information. The glare classification model may be a linear classifier that receives as input the extracted localized image feature information, the glare detection score, and an intermediate output generated by an intermediate layer of the glare scoring neural network, and to process the received input to generate the classification output. The image comprises a scan of a document. The system may further comprise a glare removal engine that processes the image, and the glare map or the extracted localized image feature information or both, to generate a processed image that mitigates glare.

The subject matter described in this specification can be implemented in particular embodiments so as to realize one or more of the following advantages. By extracting and fusing both global feature information of an image as well as localized feature information of one or more areas in the image that are each determined to include a glare component, the techniques described in this specification boost the performance of a glare detection machine learning model that is configured to process the fused extracted information to classify whether the image has glare. The glare detection machine learning model can have improved accuracy of classifications of a variety of images, even including images with predominantly white backgrounds, as including glare. In addition, an optical character recognition (OCR) system can implement the glare detection machine learning model to more efficiently and effectively process images to perform information retrieval, text extraction, and the like. The system can minimize the processing resources and human user interaction associated with detecting glare from the images, as well as allowing a glare removal process to be initiated or bypassed when appropriate.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example glare detection system.

FIG. 2 is an illustration of example operations performed by a glare detection machine learning model.

FIG. 3 is a flow diagram of an example process for detecting glare in an image.

Like reference numbers and designations in the various drawings indicate like elements.

### DETAILED DESCRIPTION

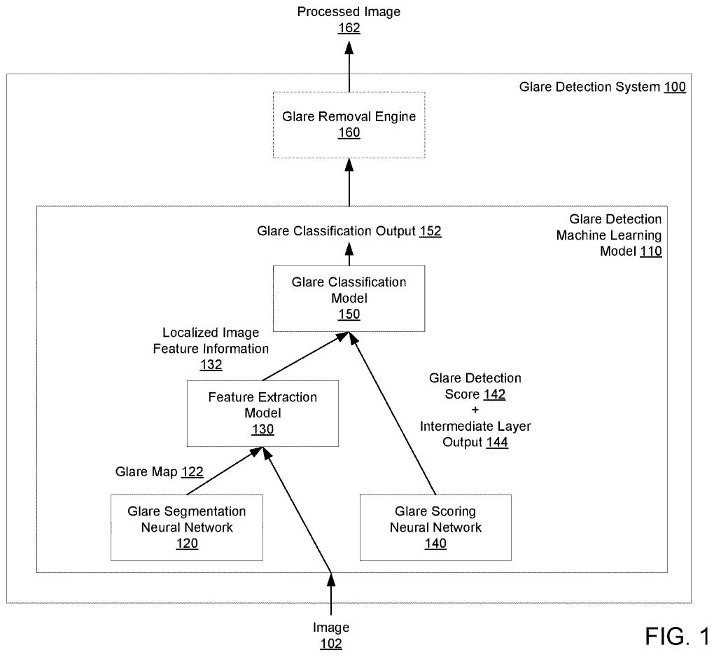

FIG. 1 shows an example glare detection system 100. The glare detection system 100 is an example of a system implemented as computer programs on one or more computers in one or more locations, in which the systems, components, and techniques described below can be implemented.

The glare detection system 100 includes a glare detection machine learning model 110 configured to process an image 102 to generate a glare classification output 152 that specifies whether the image 102 has glare.

As used herein, the term “image” can mean a digital image, such as a two-dimensional image or a three-dimensional image, or even consecutive frames of video. Images may be captured by a scanner, a camera, a specially-adapted sensor array (such as CCD array), a microscope, a smartphone camera, a video camera, etc., and stored as digital data, such a compressed image file, RAW data, etc.

The glare detection system 100 can receive the image 102 in any of a variety of ways. For example, the system 100 can receive the image 102 as an upload from a user device communicatively coupled to the system over a data communication network. As another example, the system 100 can receive an input from a user specifying, e.g., using an application programming interface (API) made available by the system 100, which data that is already maintained by the system 100 or another system accessible by the system 100 should be used as the image 102.

The glare detection machine learning model 110 is implemented with a model architecture that enables it to perform glare detection in an end-to-end manner. As illustrated in FIG. 1, the glare detection machine learning model 110 includes a glare segmentation neural network 120, a feature extraction model 130, a glare scoring neural network 140, and a glare classification model 150.

The glare segmentation neural network 120 can be a convolutional neural network, i.e., a neural network that includes one or more convolutional neural network layers. For example, the glare segmentation neural network 120 can be configured as a U-net or U-net-like neural network, examples of which are described in more detail in Dmitry Rodin, Andrey Zharkov, and Ivan Zagaynov, “Faster glare detection on document images,” in Document Analysis Systems, Xiang Bai, Dimosthenis Karatzas, and Daniel Lopresti, Eds., Cham, 2020, pp. 161-167, Springer International Publishing, and Dmitry Rodin and Nikita Orlov, “Fast glare detection in document images,” in 2019 International Conference on Document Analysis and Recognition Workshops (ICDARW). IEEE, 2019, vol. 7, pp. 6-9. Other appropriate neural networks can also be used.

The glare segmentation neural network 120 is configured to process the image 102, data derived from the image 102, or both in accordance with parameter values of the glare segmentation neural network to generate a glare map 122. A glare map as used herein refers to a digital representation of certain areas (referred to below as “glare areas”) of an image that each have been determined as likely to contain a glare component caused by a glare reflection being present in the glare area, e.g. one or more potential glare areas of the image. A glare component may be any portion of a glare that may be present in the image.

In some implementations, the glare map 122 assigns a glare score to each of one or more pixels in the image. The glare score for a pixel defines the pixel to be either a glare pixel (that is part of a glare component) or a non-glare pixel (that is not part of any glare component). For example, each glare score may range between zero to one (inclusive on both ends), with a glare score that is above a glare threshold score defining the pixel to be a glare pixel, and a glare score that is below the glare threshold score defining the pixel to be a non-glare glare pixel. In some implementations, the glare map 122 has the same resolution, i.e., assigns a glare score to each pixel in the image 102, while in other implementations, the glare map 122 has lower a resolution, i.e., assigns a same glare score to each group of multiple pixels in the image 102.

The feature extraction model 130 is configured to extract, from a model input, localized image feature information 132 that corresponds to the one or more (potential) glare areas of the image identified by the glare map 122. As will be described further below, the model input can generally include, for each of the one or more glare areas, a portion of the image 102, data derived from the portion of the image 102, a portion of the glare map 122, data derived from the portion of the glare map 122, or a combination thereof that corresponds to the glare area. While in some implementations, localized image feature information 132 is extracted with respect to each of the one or more glare areas of the image identified by the glare map 122, in other implementations, localized image feature information 132 is only extracted with respect to one selected glare area of the image among the one or more glare areas of the image that has the greatest number of pixels, i.e., with respect to the glare area that encloses the largest glare component. Because each glare area may be smaller, and sometimes much smaller, than the entire area of the image 102, the feature information extracted with respect to that area is referred to as “localized” feature information.

In some implementations, the feature extraction model 130 can use hard-coded logic to process the model input and to extract the localized image feature information 132, examples of which will be described further below, while in other implementations, the feature extraction model 130 can instead be configured as a neural network having, e.g., one or more convolutional layers, one or more fully connected layers, or both and possibly other layers that process the model input successively between them in a certain layer order and in accordance with parameter values of the feature extraction model to generate an output which may be in the form of an embedded feature vector, also referred to herein as “embedding.” The embedding may capture attributes or properties of the glare component in the glare area, as well as the context of the glare area.

The glare scoring neural network 140 can be a convolutional neural network that is configured to process the image 102 in accordance with parameter values of the glare scoring neural network to generate a glare detection score 142 that specifies whether the image 102 has glare. To generate the glare detection score 142 from the image 102, the glare scoring neural network 140 can include a stack of one or more neural network layers, e.g., convolutional neural network layers, that processes the image 102 successively between them in a certain layer, followed by a sigmoid output layer that receives the output of the last layer in the stack and generates the glare detection score 142. Since the glare scoring neural network 140 operates on the entire image, the glare detection score 142 computed by using the network is not a localized score with respect to any particular glare component and instead is indicative of a “global” estimation of whether a glare (e.g., composed of one or more glare components) is present somewhere in the image 102.

The glare classification model 150 is then configured to use both the local feature information and the global feature information to determine whether the image 102 has glare. In particular, the glare classification model 150 is configured to process a model input that includes (i) the localized image feature information 132, (ii) the glare detection score 142, and, in some implementations, (iii) an intermediate output 144 of the glare scoring neural network 140, to generate a classification output 152 that specifies whether the image 102 has glare. Typically, the intermediate output is the output of an intermediate layer of the glare scoring neural network 140 or a combination of the outputs of multiple intermediate layers of the glare scoring neural network 140. For example, the intermediate output can be the output of the penultimate layer in the glare scoring neural network 140, e.g., the output of the last convolutional layer arranged proceeding to the sigmoid output layer.

The glare classification model 150 can have any appropriate architecture that allows the model to generate the classification output 152 from the model input. Example configurations may include linear classifiers, support vector machines, kernel estimation (e.g., k-nearest neighbor), boosting, decision trees (e.g., random forests), and neural networks, although other example classifiers are also possible.

As an example for illustration, a linear classifier may be expressed as a linear function that assigns a score or likelihood to each possible class, namely “a glare is present in the image” or “no glare is present in the image,” by combining a feature vector (a concatenated vector of a first vector representing the localized image feature information 132, a second vector representing the glare detection score 142, and, optionally, a third vector representing the intermediate output of the glare scoring neural network 140) of the image 102 with a vector of weights, using a dot product. Class with the higher score or likelihood may be selected as a predicted class. For example, assigning a higher score to the class of “a glare is present in the image” than the class of “no glare is present in the image” indicates that the image 102 has been determined to have a glare by the glare detection machine learning model 110.

In some implementations, the glare classification output 152 can be provided as a final output, or used to generate the final output, of the glare detection system 100, while in other implementations, the glare classification output 152 can be provided to other components of the system 100 for further processing. For example, the glare detection system 100 can generate a prompt or notification for display on the user device that submitted the image 102 which indicates that the submitted image 102 has been determined to have a glare. Continuing with this example, the glare detection system 100 can further provide the user device with an option to mitigate the glare in the image 102 which, upon being selected, can cause the system to use a glare removal engine 160 to process the image 102, and the glare map 122 or the extracted localized image feature information 132 or both, to generate a processed image that mitigates the glare.

The glare removal engine 160 may implement any of a variety of suitable glare removal process or algorithm that is either capable of fully mitigating (i.e., fully removing) the glare, or partially mitigating (i.e., lessening the extent of) the glare on image 102. Such process or algorithms include pixel averaging, independent component analysis, relative smoothness, reflect suppression via convex optimization, and neural network-based approaches, to name just a few examples. The glare removal engine 160 can be accessed directly as a component of the glare detection system 100 or through an API or another data interface.

Moreover, the other system components can include an optical character recognition (OCR) engine that implements a text recognition algorithm to recognize texts depicted in images. The other system components can further include an information retrieval engine, a text extraction engine, or any other electronic document processing engine that can be used to process the obtained OCR text. An example of such electronic document processing engine is a machine language translation engine, which can be configured to translate the obtained OCR text from a source language to a different target language. Once generated, the final outputs of the glare detection system 100 can be utilized in various ways. For example, the final outputs can be stored at a local memory of the system, and/or transmitted to another computing device.

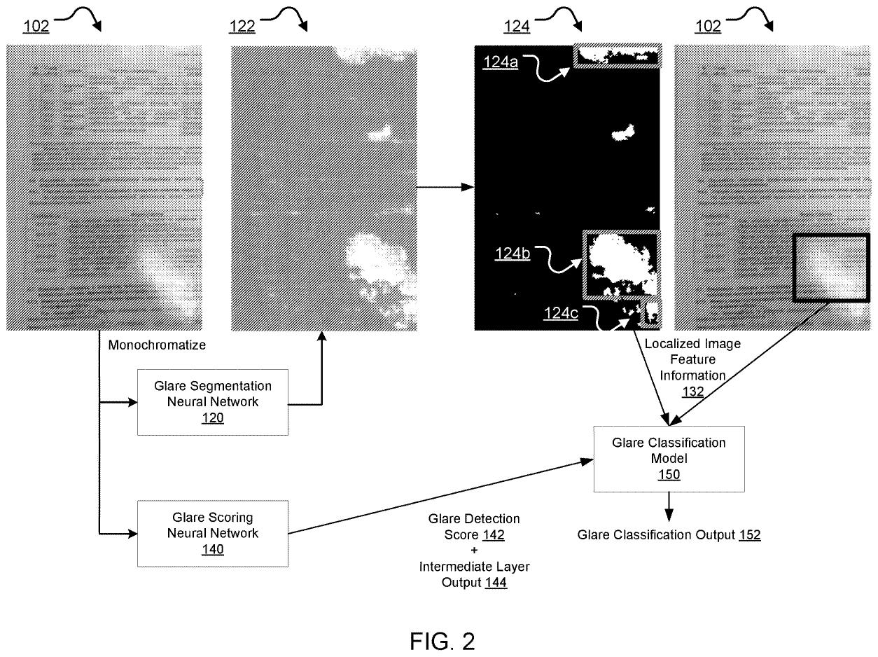

FIG. 2 is an illustration of example operations performed by the glare detection machine learning model 110 for a given image 102.

In the example of FIG. 2, the glare segmentation neural network 120 processes a monochrome version of the image 102 having the spatial resolution of H×W to generate a glare map 122 I^{seg} ∈[0,1]. The glare map may be of the same resolution as the image 102.

The glare detection machine learning model 110 then generates a binarized glare map 124 from the image 102 and from the glare map 122. In some implementations, this involves generating a first intermediate mask

$${I}_{max}^{seg}$$

by determining, for each pixel in the image 102, a maximum color value among color values for all color channels (red, green, and blue channels) of the pixel that satisfy a first threshold Γₘₐₓ:

$${I}_{max}^{s e g} ( x , y ) = max ( {I}_{R} ( x , y ) , {I}_{G} ( x , y ) , {I}_{B} ( x , y ) ) > {Γ}_{max} ;$$

and generating a second intermediate mask

$${I}_{grey}^{seg}$$

by determining glare scores in the glare map 122 that satisfy a second threshold Γ_{grey}:

$${I}_{grey}^{seg} = {I}^{seg} > {Γ}_{grey} .$$

In these implementations, the binarized glare map 124 is then generated by determining a combination of the first intermediate mask

$${I}_{max}^{seg}$$

and the second

$${I}_{grey}^{seg} :$$

$${I}_{binary}^{seg} = {I}_{max}^{seg} AND {I}_{grey}^{seg} .$$

As illustrated, the binarized glare map 124 generated in this way has positive glare scores (binarized glare scores indicating that the corresponding pixels are glare pixels) clustered into one or more segments 124a-c, with each segment being indicative of a contour as well as a size of a corresponding glare component.

The glare detection machine learning model 110 processes the binarized glare map 124 to generate a corresponding bounding box around each segment, e.g., each of segments 124a-c. Although FIG. 2 illustrates each bounding box as having a rectangular shape, this is not required. For example, the bounding box may have another geometric shape such as circle or other shape. Each bounding box may additionally include negative glare scores (binarized glare scores indicating that the corresponding pixels are non-glare pixels), e.g., outside of the positive glare scores that are clustered together.

In some implementations, as illustrated in the example of FIG. 2, localized image feature information 132a and 132b is extracted with respect to the glare area that encloses the largest glare component in term of pixels (the glare component represented by glare score segment 124b in the example of FIG. 2), while in other implementations, localized image feature information is extracted with respect to the glare area represented by each of the multiple clusters of glare score segment.

The localized image feature information 132 is extracted, e.g., in accordance with hard-coded logic or a neural network, from both (i) Rect*, the portion of the binarized glare map 124 identified by the bounding box that surrounds the largest glare score segment 124b, and from (ii) I_{R*}, the portion of the image 102 that corresponds to the area identified by the bounding box defined with reference to the binarized glare map 124 that surrounds the largest glare score segment 124b. The localized image feature information 132 can include one or more of: dark channel gradient energy, saturation and intensity (SV) product, Kullback-Leibler (KL) divergence of histogram, standard deviation and contrast, contour mean, hue standard deviation, saturation mean difference, median saturation of contour, or bounding box fraction.

### Dark Channel Gradient Energy

This feature is extracted from (the horizontal and vertical edge maps) of the portion of a dark channel image

$${I}_{R}^{dark}$$

that corresponds to Rect*:

$${f}_{dark} = \frac{1}{{H}_{R} {W}_{R}} {\sum }_{x , y} \sqrt{{( {Δ}_{x} {I}_{R}^{dark} ( x , y ) )}^{2} + {( {Δ}_{y} {I}_{R}^{dark} ( x , y ) )}^{2}} ,$$

where Δx and Δy are the horizontal and vertical edge detection operators, respectively, and the dark channel image, I^{dark}, is given by the minimum channel value at each pixel location of the image:

$${I}^{dark} ( x , y ) = {min}_{C ∈ R , G , B} {I}_{C} ( x , y ) .$$

Hr and Wr are the height and width respectively of the portion of the image 102 that corresponds to the area identified by the bounding box defined with reference to the binarized glare map 124 that surrounds the largest glare score segment 124b, e.g. the cropped region.

### Saturation and Intensity (SV) Product

This feature is given by:

$${f}_{SV} = \frac{1}{{H}_{R} {W}_{R}} {\sum }_{x , y} ( 1 - S ( {I}_{R} \text{?} ( x , y ) ) ) \times V ( {I}_{R} \text{?} ( x , y ) ) .$$

$$\text{?} \text{indicates text missing or illegible when filed}$$

where S is the saturation plane and V is the intensity plane. Near a glare region, S(·) tends to 0 while V(·) tends 1; thus f_{SV} tends to 1. The value tends to be lower on other non-glare regions.

### Kullback-Leibler (KL) Divergence of Histogram

This feature measures the difference between the histograms of I_{R*} and the masked version of I_{R*}. For example:

where S(·) represents the saturation plane of the image.

### Standard Deviation and Contrast

This feature measures the standard deviation and contrast within I_{R*} in the saturation space.

### Contour Mean

This feature measures the mean saturation value inside the masked version of I_{R*};

$${f}_{mean} = \frac{{\sum }_{x , y \text{?} Rect \text{?} ( x , y ) = 1} S ( {I}_{R} \cdot ( x , y ) ) \times Rect \text{?} ( x , y )}{{\sum }_{x , y \text{?} Rect \text{?} ( x , y ) = 1} 1} .$$

$$\text{?} \text{indicates text missing or illegible when filed}$$

### Hue Standard Deviation

This feature measures the standard deviation of hue values of pixel within I_{R*}.

### Saturation Mean Difference

This feature measures the difference between the mean saturation values of S(I_{R*}) and S(I_{R*}⊙Rect*).

### Median Saturation of Contour

This feature measures the median saturation value of non-zero pixels inside I_{R*} masked with Rect+.

### Bounding Box Fraction

This feature measures the fraction of the entire image covered by the bounding box(es).

The glare scoring neural network 140 processes the image 102 in accordance with parameter values of the glare scoring neural network to generate a glare detection score 142 that specifies whether the image 102 has glare.

Lastly, the glare classification model 150 processes a model input that includes (i) the localized image feature information 132, (ii) the glare detection score 142, and, in some implementations, (iii) an intermediate output 144 of the glare scoring neural network 140, e.g., the output of the penultimate layer in the glare scoring neural network 140, to generate a classification output 152 that specifies whether the image 102 has glare. The classification output 152 may comprise a binary indication, e.g. whether or not the image has glare. Alternatively, the classification output 152 may comprise a numerical indication of the likelihood that the image 102 has glare, e.g. a probability that the image 102 has glare.

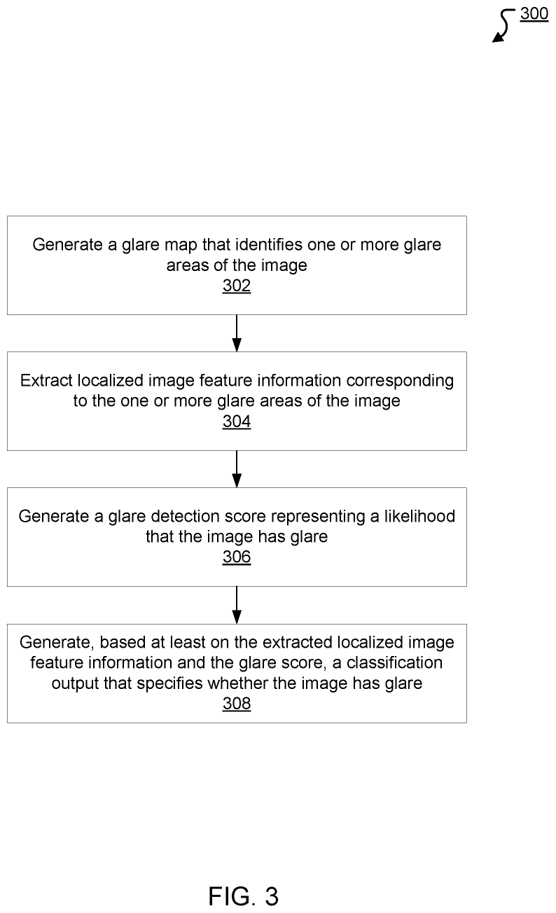

FIG. 3 is a flow diagram of an example process 300 for detecting glare in an image. For convenience, the process 300 will be described as being performed by a system of one or more computers located in one or more locations. For example, a system, e.g., the glare detection system 100 of FIG. 1, appropriately programmed in accordance with this specification, can perform the process 300.

The process 300 can be performed for any image in order to determine whether the image has glare, i.e., whether the image includes any glare components caused by glare reflection. For example, the image may be provided by a user of the system, or obtained by the system from another source. For example, the image may include a scan of a document.

The system generates, based on using a glare segmentation neural network to process the image, data derived from the image, or both, a glare map that identifies one or more glare areas of the image (302). Each glare area can be viewed as a proper subset of an area of the image that has been determined to include a glare component caused by a glare reflection being present in the glare area.

In some implementations, the glare segmentation neural network is configured to processes a monochrome version of the image to generate the glare map that assigns a glare score to each of one or more pixels in the image. In some of these implementations, each glare score can range between zero to one (inclusive on both ends), with a glare score that is above a glare threshold score defining the pixel to be a glare pixel, and a glare score that is below the glare threshold score defining the pixel to be a non-glare glare pixel.

The system extracts, by using a feature extraction model, localized image feature information corresponding to the one or more glare areas of the image (304). In some implementations, the feature extraction model can use hard-coded logic to extract, from the model input, one or more of the following features: dark channel gradient energy, saturation and intensity (SV) product, Kullback-Leibler (KL) divergence of histogram, standard deviation and contrast, contour mean, hue standard deviation, saturation mean difference, median saturation of contour, or bounding box fraction. In other implementations, the feature extraction model can instead be configured as a convolutional neural network that generates an embedded feature vector output from the model input that represent the localized image feature information. In either implementation, the model input can generally include, for each of the one or more glare areas, a portion of the image, data derived from the portion of the image, a portion of the glare map, data derived from the portion of the glare map, or a combination thereof that corresponds to the glare area.

While in some implementations, the system extracts localized image feature information with respect to each of the one or more glare areas of the image identified by the glare map, in other implementations, the system only extracts localized image feature information with respect to one selected glare area of the image among the one or more glare areas of the image that has the greatest number of pixels, i.e., with respect to the glare area that encloses the largest glare component.

The system generates, based on using a glare scoring neural network to process the image, a glare detection score representing a likelihood that the image has glare (306). In some implementations, the glare scoring neural network can be configured as a convolutional neural network that includes a stack of one or more convolutional neural network layers that processes the image successively between them in a certain layer, followed by a sigmoid output layer that receives the output of the last layer in the stack and generates the glare detection score.

The system generates, based on using a glare classification model to process (i) the extracted localized image feature information, (ii) the glare detection score, and, in some implementations, (iii) an intermediate output of the glare scoring neural network, a classification output that specifies whether the image has glare (308). In some implementations, the intermediate output is the output generated by the penultimate layer in the glare scoring neural network, e.g., the output of the last convolutional layer arranged proceeding to the sigmoid output layer. In some implementations, the glare classification model can be configured as a linear classifier.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system for detecting glare in an image, the system comprising one or more computers and one or more storage devices storing instructions that, when executed by the one or more computers, cause the one or more computers to perform one or more operations to implement a glare detection machine learning model, the glare detection machine learning model comprising:
a glare segmentation neural network that generates, from data derived from the image, a glare map that identifies one or more glare areas of the image, each glare area being a proper subset of an area of the image and determined to include a glare component caused by a glare reflection being present in the glare area;
a feature extraction model that extracts localized image feature information corresponding to the one or more glare areas of the image;
a glare scoring neural network that processes the image to generate a glare detection score representing a likelihood that the image has glare; and
a glare classification model that uses at least the extracted localized image feature information and the glare detection score to generate a classification output that specifies whether the image has glare.

2. The system of claim 1, wherein the one or more glare areas of the image comprises a selected glare area of the image among the one or more glare areas of the image that has the greatest number of pixels.

3. The system of any of claim 1, wherein the glare segmentation neural network and the glare scoring neural network are each a respective convolutional neural network having a respective plurality of neural network layers.

4. The system of claim 1, wherein the glare segmentation neural network processes a monochrome version of the image to generate the glare map that assigns a glare score to each of one or more pixels in the image.

5. The system of claim 1, wherein the glare detection machine learning model further generates a binarized glare map from the image and from the glare map by determining color channel values that satisfy a first threshold and glare scores that satisfy a second threshold.

6. The system of claim 5, wherein the binarized glare map is partitioned into one or more segments, each segment indicative of a contour of a corresponding glare component.

7. The system of claim 6, wherein the feature extraction model extracts localized image feature information corresponding to the one or more identified areas of the image based on processing the binarized glare map, the image, or both.

8. The system of claim 7, wherein the localized image feature information comprises one or more of: dark channel gradient energy, saturation and intensity (SV) product, Kullback-Leibler (KL) divergence of histogram, standard deviation and contrast, contour mean, hue standard deviation, saturation mean difference, median saturation of contour, or bounding box fraction.

9. The system of claim 5, wherein the feature extraction model is a convolutional neural network that processes the binarized glare map, the image, or both to generate an embedded feature vector that represents the localized image feature information.

10. The system of claim 3, wherein the glare classification model is a linear classifier that receives as input the extracted localized image feature information, the glare detection score, and an intermediate output generated by an intermediate layer of the glare scoring neural network, and to process the received input to generate the classification output.

11. The system of claim 1, wherein the image comprises a scan of a document.

12. The system of claim 1, further comprising a glare removal engine that processes the image, and the glare map or the extracted localized image feature information or both, to generate a processed image that mitigates glare.

13. A method for detecting glare in an image, the method comprising:
generating, based on using a glare segmentation neural network to process data derived from the image, a glare map that identifies one or more glare areas of the image, each glare area being a proper subset of an area of the image and determined to include a glare component caused by a glare reflection being present in the glare area;
extracting, by using a feature extraction model, localized image feature information corresponding to the one or more glare areas of the image;
generating, based on using a glare scoring neural network to process the image, a glare detection score representing a likelihood that the image has glare; and
generating, based on using a glare classification model to process at least the extracted localized image feature information and the glare detection score, a classification output that specifies whether the image has glare.

14. The method of claim 13, wherein the one or more identified areas of the image comprises a selected identified area of the image among the one or more identified areas of the image that has the greatest number of pixels.

15. The method of claim 13, wherein the glare segmentation neural network and the glare scoring neural network are each a respective convolutional neural network having a respective plurality of neural network layers.

16. The method of claim 13, wherein the glare segmentation neural network processes a monochrome version of the image to generate the glare map that assigns a glare score to each of one or more pixels in the image.

17. The method of claim 13, wherein the glare detection machine learning model further generates a binarized glare map from the image and from the glare map by determining color channel values that satisfy a first threshold and glare scores that satisfy a second threshold.

18. The method of claim 17, wherein the binarized glare map is partitioned into one or more segments, each segment indicative of a contour of a corresponding glare component.

19. The method of claim 18, wherein the feature extraction model extracts localized image feature information corresponding to the one or more identified areas of the image based on processing the binarized glare map, the image, or both.

20. One or more non-transitory computer-readable storage media storing instructions that when executed by one or more computers cause the one or more computers to perform operations to implement a glare detection machine learning model, the glare detection machine learning model comprising:
a glare segmentation neural network that generates, from data derived from the image, a glare map that identifies one or more glare areas of the image, each glare area being a proper subset of an area of the image and determined to include glare component caused by a glare reflection being present in the glare area;
a feature extraction model that extracts localized image feature information corresponding to the one or more glare areas of the image;
a glare scoring neural network that processes the image to generate a glare detection score representing a likelihood that the image has glare; and
a glare classification model that uses at least the extracted localized image feature information and the glare detection score to generate a classification output that specifies whether the image has glare.
